(19) United States
(12) Patent Application Publication
(10) Pub. No.: US 2014/0102968 A1
(43) Pub. Date: Apr. 17, 2014

(54) Pure-Sip

(71) Applicant: John James McEncroe, Golden, CO (US)

(72) Inventor: John James McEncroe, Golden, CO (US)

(21) Appl. No.: 13/998,189

(22) Filed: Oct. 3, 2013

Related U.S. Application Data
(63) Continuation of application No. 12/576,645, filed on Oct. 9, 2009, now abandoned.

(51) Int. Cl. C02F 9/00

(52) U.S. Cl. CPC C02F 9/005
USPC 210/251

(57) ABSTRACT

Endocrine disrupting compounds are routinely detected in the treated water leaving our municipal drinking water plants; however, until relatively recent advances in laboratory analysis capabilities, the trace amounts of these chemicals was not measurable. At an enormous cost we can remove these compounds using centralized municipal water treatment, but does it make sense to do so when less than 1% of our municipal water supply is ingested? Furthermore, ⅓ of waterborne disease outbreaks can be traced to contamination entering our water distribution systems after centralized treatment. The regulatory community and municipal water industry are truly at a crossroads, even if a staggering investment is made to remove endocrine disrupting compounds using centralized treatment, our treated water distribution systems will always be subject to contamination. The countertop (portable) “Pure Sip”™ low voltage Point-of-Use water treatment system uses filtration, adsorption, and UV disinfection to reliably and economically address these exposures.

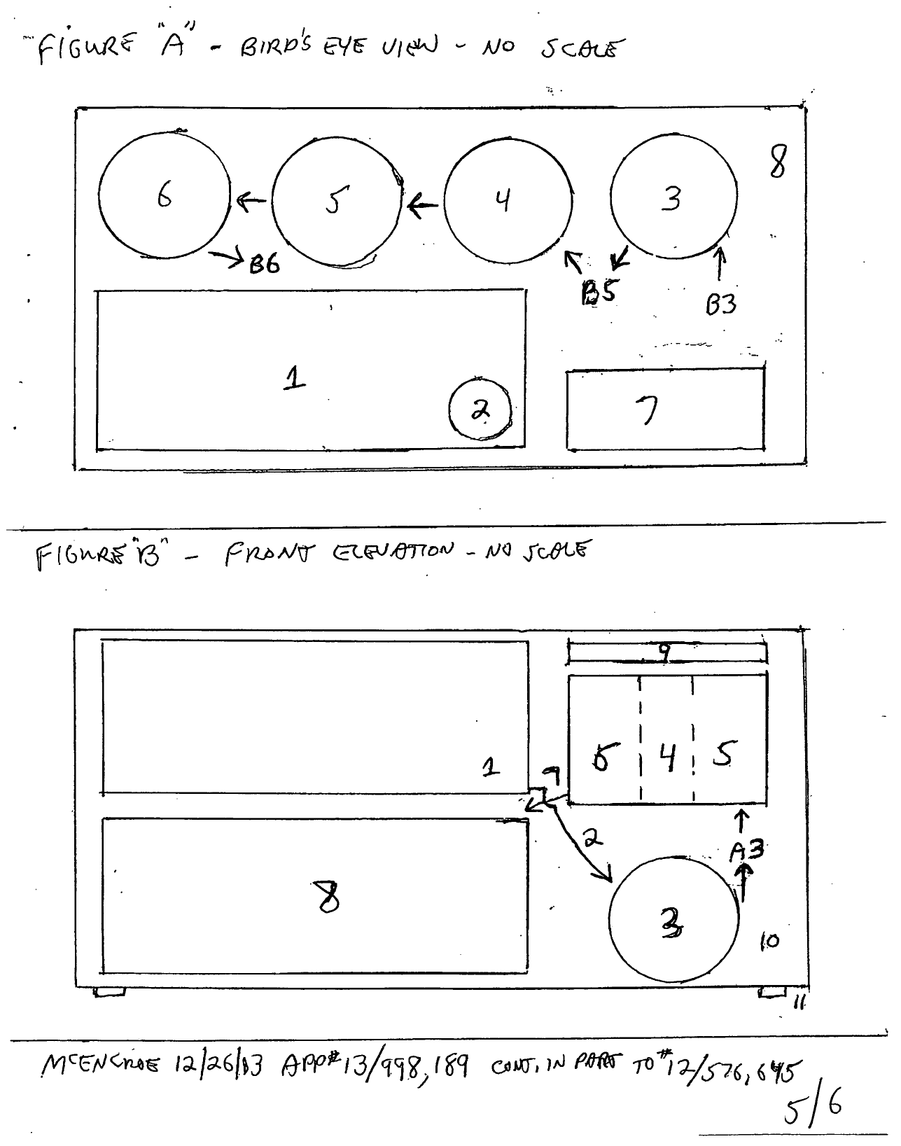

The system for which I seek a process patent uses existing technologies in a configuration which is unique and which provides requisite flexibility for everyday use in the home, portable use away from home, and water purification during civil emergencies. Unlike bottled water which is processed in a controlled environment and then distributed in tamper evident packaging (and which may be unavailable during civil emergencies when most needed), municipally treated water is pumped through a complicated water distribution system in which there are numerous potential places for contamination and which are not under the direct control of the water supplier. Indeed, one study found that 30.3% of waterborne disease outbreaks in the United States could be traced to our treated water distribution systems (Craun & Calderon 2001). The “Pure-Sip” Point-of-Use process can essentially eliminate outbreaks related to distribution system contamination events. In addition to concerns with contamination of treated water within our distribution systems, there are trace amounts of human made chemicals, such as endocrine disrupting compounds, which are routinely detected in the treated water leaving our municipal drinking water plants. Until relatively recent advances in laboratory analysis capabilities the presence of trace amounts of these chemicals was not measurable. Dr. Joerg Drewes (formerly at Colorado School of Mines and now at the University of Munich) stated his concern about these chemicals as follows: “In addition to concerns about individual endocrine disrupting compounds, there is concern about the cocktail effect of numerous micropollutants and/or their metabolites” (lecture notes from ESGN 603 at Colorado School of Mines, Sep. 9, 2004). Indeed, there are over 83,000 chemicals currently in the TSCA inventory (testimony before the Subcommittee on Commerce, Trade, and Consumer Protection, Committee on Energy and Commerce, House of Representatives by John Stephenson, Director Natural Resources and the Environment—GAO, Fe. 26, 2009, GAO-09-428T “Chemical Regulation, Options for Enhancing the Effectiveness of TSCA”). The regulatory community and municipal water industry are at a crossroads. At an enormous cost we can remove these trace contaminants using centralized municipal water treatment, but does it make sense to do so when less than 1% of our municipal water supply is ingested (Vickers 2001), and when we know that ⅓ of disease outbreaks attributable to our potable water systems can be traced to our water distribution systems?

There are numerous manufacturers of “Point-of-Use” water treatment systems. My unique “Pure Sip” Point-of-Use treatment system is a logical, economical, and effective, addition to the water industry's traditional “multiple barrier” treatment strategy. Although under counter systems are preferred from an aesthetic standpoint, they are “out of sight—out of mind” and their installation and maintenance will be perceived as problematic, or essentially impossible, by most utilities (please note however that my process allows for such installation by the use of commonly available quick disconnect couplings in the influent and effluent tanks for connection to the water supply line [or sink faucet] and to a dedicated faucet). To be successful in persuading the EPA, state and local Health Departments, and Utilities to embrace Point-of-Use, they need a free standing countertop design which eliminates the nebulous variables and costs related to under counter installations, is convenient for the citizen and the utility to swap out on a scheduled basis (generally every six months, but variable depending on water system quality), and which protects the user against microbiological, inorganic, and organic contaminants. Although reverse osmosis systems can provide a high degree of purity, healthful minerals are removed from the water and a liquid waste stream is generated which must be disposed of; the system I have designed will not remove these beneficial constituents nor will it generate a liquid waste stream.

One of the biggest drawbacks of systems which use carbon adsorption for organics (and chlorine) removal is that there is no method supplied with any system to determine the efficacy of the adsorption system. It is quite possible that subsequent to a serious distribution system event, that the homeowner would mistakenly believe that adsorption is occurring, when in fact the carbon's adsorption ability has been seriously compromised or exhausted. As such, a chlorine disinfectant residual test kit is included as part of the system (the vast majority of the time there will be a chlorine residual in the influent to the system and no residual in the effluent {which would indicate effective adsorption}).

The system is designed to produce potable water wherever there is a 12 volt power source (or other “safe” low voltage), and highly filtered water through the use of a syringe as a power source even in the event of the failure of the system's 12 volt UV portion as well as the 12 volt pump (note that as long as one of the 4 available filter cartridge slots employs a<0.45 μm filter, that pathogenic bacteria will be physically excluded).

Attached are Figures A & B, a detailed description of the “Pure-Sip” process as displayed in those Figures is as follows:

Figure “A” is a “Bird's eye” view of the system/process:

A1—influent water tank

A2—drain/supply which incorporates a quick disconnect to allow direct connection to the municipal water supply or for use as a syringe connection when B3, the system pump fails, or in emergency situations. Opening is engineered to ensure adequate contact time with NSF 55 ultraviolet disinfection system.

A3—First stage cartridge filtration at<50 μm to remove relatively large particles which can shield pathogens from ultraviolet disinfection supplied by B4. A3 is supplied by pump B3→Discharge from A3 is to ultraviolet contact chamber B5→discharge from B5 is to A4

A4-6: 2^{nd}, 3^{rd}, and 4^{th} stage filtration/adsorption (and/or ionic bonding) followed by B6, a second round of NSF 55 primary UV disinfection.

A7—electrical connection/logic board/system controller

A8—removable lid to allow filling of influent tank

Figure “B” is a front elevation of the system/process:

B1—Influent tank

B2—Line from influent tank to B3 (pump)

B3—A 12 VDC (or other safe low voltage supply) powered centrifugal pump. Flow from B3 (pump) is to A3 (first stage cartridge filtration) to B5 (1^{st} stage ultraviolet disinfection which is supplied by ultraviolet source B4)

B5—NSF 55 ultraviolet pre-disinfection→then to A4-6 (2^{nd}, 3^{rd}, and 4^{th} stage filtration/adsorption).

B6—NSF 55 ultraviolet post-disinfection (subsequent to filtration/adsorption at A4-6)

B7—Supply line from ultraviolet post-disinfection to B8—effluent water tank (supplied with a quick disconnect fitting for those wishing to connect the system to a dedicated faucet at the sink). The effluent tank is bigger than the influent tank to avoid accidental spills.

B9—Electrical connection/logic board/system controller

B10—Easily removable cover to allow removal of effluent tank and/or service of components

B11—System support pads

Documentation of my efforts to gain acceptance for Point-of-Use technologies in the potable water industry's multiple barrier approach to public health includes the following national/international forums:
1. Water Technology, November 2012
   http://www.watertechonline-digital.com/201211/201211#&pageSet=0; p. 2 & p. 17-18
2. Water Technology, August 2011 (in which essentially all aspects of my process were presented)
3. 2011 International Conference of the Water Quality Association,
4. 2010 National Conference of the American Water Works Association
5. Journal of the American Water Works Association, February 2007

### References Cited

| 8,177,966 B2 | May 15, 2012 | Wu |
|---|---|---|
| 7,632,410 B2 | Dec. 15, 2009 | Heiss |
| 7,404,894 | Jul. 29, 2008 | Yamaguchi |
| 7,252,763 B2 | Aug. 7, 2007 | Kuennen |
| 2006/0186026 A1 | Aug. 24, 2006 | Saleh |
| 7,090,779 | Oct. 20, 2004 | Berstein |
| 6,841,876 B1 | Sep. 9, 2004 | Neal |
| 6,579,445 B2 | Jun. 17, 2003 | Nachtman |
| 6,478,956 | Nov. 12, 2002 | Kaura |
| 6,464,884 B1 | Oct. 15, 2002 | Gadgil |
| 6,451,202 B1 | Sep. 17, 2002 | Kuennen |
| 6,402,949 | Jun. 11, 2002 | Banks |
| 6,379,544 | Apr. 30, 2002 | Chen |
| 6,344,146 | Feb. 5, 2002 | Moorehead |
| 6,024,867 | Feb. 15, 2000 | Parise |
| 6,120,691 | Sep. 19, 2000 | Mancil |
| 5,853,572 | Dec. 29, 1998 | Kuennen |
| 5,656,160 | Aug. 12, 1997 | Parise |
| 5,433,848 | Jul. 18, 1995 | Platter |
| 5,078,876 | Jan. 7, 1992 | Whittier |
| 4,902,411 | Feb. 20, 1990 | Lin |
| 4,556,484 | Dec. 3, 1985 | Hunter |

Please note that my understanding from reading material on the USPTO website is that I am only required to document those patents granted within the past 20 years which are, or may be, related to my system (so I did not include older patents).

1. The first 12 volt DC (other “safe” low voltages are included) countertop “Point of Use” water treatment system which will fit in the typical 18″ space found between overhead and base cabinets in a kitchen which incorporates the following processes in a single unit in this order:
i. A flow inhibitor device to ensure adequate contact time with the UV source for disinfection, and with the carbon block filter(s) to ensure adequate adsorption time for organics removal
ii. A≦50 micron particle/sediment filter (upstream of UV disinfection to minimize dispersion/blockage of UV energy and upstream of≦3.0 micron filtration to avoid premature clogging)
iii. Class “A” Ultraviolet disinfection which meets NSF 55 to inactivate opportunistic or frank pathogens
iv. ≦3.0 micron filtration for inorganics and microbial removal coupled with carbon adsorption for organics removal (the chassis is designed to accommodate up to four filtration/adsorption cartridges for highly impacted waters, including those with polar compounds)
v. Class “A” Ultraviolet disinfection which meets NSF 55 to inactivate opportunistic or frank pathogens which survive the 1^{st} stage UV disinfection

2. The system is portable so that it can be used anywhere a 12 Volt DC (or other “safe” low voltage is available), the low voltage powers the Ultraviolet disinfection processes as well as the system pump.

3. A syringe is included which will allow manually forcing water through the components in the event of pump failure, unavailability of a low voltage power source, or civil emergency. Those units equipped with ≦˜0.45 micron filtration will physically exclude pathogenic bacteria. The syringe connection at the influent tank is generic so that those wishing to connect the system to a faucet or under counter could have the same connectors on their house plumbing (the same applies to the effluent tank connection upstream of a dedicated faucet).

4. A chlorine disinfectant residual test kit is included as part of the system; absence of chlorine in the unit's effluent serves as a surrogate to verify the efficacy of the carbon block filter(s) at adsorbing organic contaminants.
